(19) United States
(12) Patent Application Publication
(10) Pub. No.: US 2026/0217561 A1
(43) Pub. Date: Jul. 30, 2026

(54) METHOD FOR PRODUCING POSITIVE ELECTRODE ACTIVE MATERIAL FOR SECONDARY BATTERIES

(71) Applicant: Panasonic Energy Co., Ltd., Moriguchi-shi, Osaka (JP)

(72) Inventors: Yuki Hirano, Osaka (JP); Kaoru Nagata, Osaka (JP); Takeshi Ogasawara, Hyogo (JP); Katsuya Inoue, Hyogo (JP); Akihiro Kawakita, Hyogo (JP)

(73) Assignee: Panasonic Energy Co., Ltd., Moriguchi-shi, Osaka (JP)

(21) Appl. No.: 19/142,752

(22) PCT Filed: Dec. 12, 2023
(86) PCT No.: PCT/JP2023/044441

§ 371 Date: Jun. 24, 2025

(30) Foreign Application Priority Data
Dec. 28, 2022 (JP) 2022-211623

(51) Int. Cl. C01G 53/506; H01M 4/02; H01M 4/525

(52) U.S. Cl. CPC C01G 53/506; H01M 4/525; C01P 2006/40; H01M 2004/028

(57) ABSTRACT

A method for producing a positive electrode active material for secondary batteries according to the present invention is characterized by comprising: a water washing step in which a slurry that is obtained by mixing an Ni-containing lithium transition metal oxide with water or an aqueous solution is stirred, thereby water washing the Ni-containing lithium transition metal oxide; a solid-liquid separation step in which the slurry is subjected to solid-liquid separation, thereby obtaining a cake that contains the Ni-containing lithium transition metal oxide; and a drying step in which the cake is dried. This method for producing a positive electrode active material for secondary batteries is also characterized in that a sulfonic acid compound represented by general formula (I) (wherein A represents H, Li or Na, and R represents H or a hydrocarbon group) is added to the slurry in the water washing step.

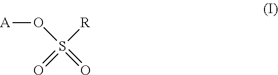

### TECHNICAL FIELD

The present disclosure relates to a method for manufacturing a positive electrode active material for a secondary battery.

### BACKGROUND

A lithium transition metal oxide used as a positive electrode active material for a secondary battery preferably contains Ni, for example, from the viewpoint of increasing the capacity of the battery. However, if a Ni-containing lithium transition metal oxide is used as a positive electrode active material for a secondary battery, the reaction resistance of the positive electrode may be increased to increase the DC resistance of the battery.

For improvement in battery characteristics such as reduction of the DC resistance of a battery, a technique has been conventionally known in which a sulfonic acid compound is attached to the particle surface of a lithium transition metal oxide. For example, Patent Literature 1 discloses a positive electrode active material in which a Li salt of an acid having a structure represented by the general formula: X1-R—X2 (in the formula, X1 and X2 are a sulfo group (—SO₃H)) is interspersed on the particle surface of a lithium transition metal oxide.

### CITATION LIST

### Patent Literature

Patent Literature 1: JP 2019-169286 A

### SUMMARY

As described above, a positive electrode active material for a secondary battery in which a sulfonic acid compound is attached to the particle surface of a lithium transition metal oxide has been known, but a method for manufacturing the positive electrode active material is not established. Even if a sulfonic acid compound is simply added to a lithium transition metal oxide in order to attach the sulfonic acid compound to the particle surface of the lithium transition metal oxide, a sufficient amount of the sulfonic acid compound attached to the particle surface of the lithium transition metal oxide cannot be obtained.

Therefore, an object of the present disclosure is to provide a method for manufacturing a positive electrode active material for a secondary battery, capable of improving the amount of a sulfonic acid compound attached to the particle surface of a Ni-containing lithium transition metal oxide.

A method for manufacturing a positive electrode active material for a secondary battery according to one aspect of the present disclosure includes a water washing step of mixing a Ni-containing lithium transition metal oxide and water or an aqueous solution to obtain a slurry and stirring the slurry to water-wash the Ni-containing lithium transition metal oxide, a solid-liquid separation step of separating the slurry into a solid and a liquid to obtain a cake containing the Ni-containing lithium transition metal oxide, and a drying step of drying the cake, and the water washing step includes adding a sulfonic acid compound to the slurry, the sulfonic acid compound represented by General Formula (I) described below:

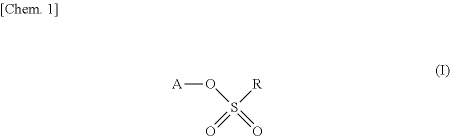

wherein A represents H, Li, or Na, and R represents H or a hydrocarbon group.

According to one aspect of the present disclosure, it is possible to improve the amount of the sulfonic acid compound attached to the particle surface of the Ni-containing lithium transition metal oxide.

### DESCRIPTION OF EMBODIMENTS

A method for manufacturing a positive electrode active material for a secondary battery according to the present embodiment includes a water washing step of mixing a Ni-containing lithium transition metal oxide and water or an aqueous solution to obtain a slurry and stirring the slurry to water-wash the Ni-containing lithium transition metal oxide, a solid-liquid separation step of separating the slurry into a solid and a liquid to obtain a cake containing the Ni-containing lithium transition metal oxide, and a drying step of drying the cake. Hereinafter, each step of the method for manufacturing a positive electrode active material for a secondary battery according to the present embodiment will be described in detail.

### (Water Washing Step)

The water washing step is a step of mixing a Ni-containing lithium transition metal oxide and water or an aqueous solution to obtain a slurry and stirring the slurry to water-wash the Ni-containing lithium transition metal oxide. Then, in the water washing step, a sulfonic acid compound described below is added to the above slurry. Thus, the sulfonic acid compound can be attached to the particle surface of the Ni-containing lithium transition metal oxide.

The Ni-containing lithium transition metal oxide before the water washing step may have a particle surface on which a lithium compound (for example, lithium carbonate) and the like used at the time of synthesis remain in an unreacted state. However, if the water washing step is performed, it is possible to remove the unreacted lithium compound and the like remaining on the particle surface of the Ni-containing lithium transition metal oxide. As a result, in the Ni-containing lithium transition metal oxide, the number of pores on the particle surface and the particle surface area are increased, and therefore it is possible to promote attachment of the sulfonic acid compound to the particle surface of the Ni-containing lithium transition metal oxide. Therefore, the addition of the sulfonic acid compound in the water washing step can improve the amount of the sulfonic acid compound attached to the particle surface of the Ni-containing lithium transition metal oxide. For example, the sulfonic acid compound can be attached, in an amount of greater than or equal to 80 mass % of the total amount of the sulfonic acid compound added to the slurry, to the particle surface of the Ni-containing lithium transition metal oxide.

As the Ni-containing lithium transition metal oxide, one obtained using a known technique can be used. For example, the Ni-containing lithium transition metal oxide can be obtained by mixing a lithium compound with a Ni composite hydroxide obtained by co-precipitating (crystallizing) metal elements, other than lithium, included in the Ni-containing lithium transition metal oxide or with a Ni composite oxide obtained by further heat-treating the Ni composite hydroxide, and then firing the obtained lithium mixture. The lithium compound is, for example, lithium carbonate, lithium hydroxide, or the like.

The Ni-containing lithium transition metal oxide may contain an element other than Ni and Li. Examples of the element other than Ni and Li include Co, Mn, Al, B, Mg, Ti, V, Cr, Fe, Cu, Zn, Ga, Sr, Zr, Nb, In, Sn, Ta, and W. Examples of the Ni-containing lithium transition metal oxide include an oxide represented by the general formula: Li_{b}Ni₁₋ₓMₓO_{2+β} (wherein 0≤x≤0.35, 0.95≤b≤1.20, 0≤β≤0.5, and M represents at least one element selected from Co, Mn, Al, B, Mg, Ti, V, Cr, Fe, Cu, Zn, Ga, Sr, Zr, Nb, In, Sn, Ta, and W).

The sulfonic acid compound is represented by General Formula (I) described below.

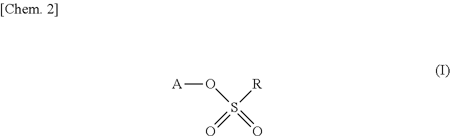

In the formula, A represents H, Li, or Na. R represents H or a hydrocarbon group. The hydrocarbon group is preferably, for example, a hydrocarbon having 1 to 24 carbon atoms. Examples of the hydrocarbon group include alkyl groups, alkenyl groups, and aryl groups. Examples of the alkyl groups include a methyl group, an ethyl group, propyl groups (including n-propyl and iso-propyl groups), butyl groups (including n-butyl, t-butyl, iso-butyl, and sec-butyl groups), and hexyl groups (including its branched and linear isomers). Examples of the alkenyl groups include a vinyl group, an allyl group, and hexenyl groups (including its branched and linear isomers). Examples of the aryl groups include a phenyl group, a tolyl group, a xylyl group, a naphthyl group, and a benzyl group.

The sulfonic acid compound may be added in a form of a powder of the sulfonic acid compound or a form of a solution containing the sulfonic acid compound. The solution containing the sulfonic acid compound is not particularly limited as long as it contains a sulfonic acid compound, but a solution is preferable that is obtained by dissolving a sulfonic acid compound in an alkali aqueous solution such as lithium hydroxide or sodium hydroxide. The sulfonic acid compound concentration in the solution containing the sulfonic acid compound is, for example, greater than or equal to 0.5 mol/L and less than or equal to 15 mol/L. The pH of the solution containing the sulfonic acid compound may be, for example, in a range of 0.1 to 12, and preferably in a range of 7 to 11.

The water washing may be a known method. For example, the Ni-containing lithium transition metal oxide and water or an aqueous solution are put into a reaction tank equipped with a stirrer, and stirred. Then, at a predetermined timing, the powder of the sulfonic acid compound or the solution containing the sulfonic acid compound is put into the above reaction tank and stirred.

The sulfonic acid compound may be added at the timing of immediately after the start of the water washing step, but from the viewpoint of capability of further improving the amount of the sulfonic acid compound attached to the particle surface of the lithium transition metal oxide, the sulfonic acid compound is preferably added after the atomic concentration ratio of Li/Ni on the particle surface of the Ni-containing lithium transition metal oxide becomes less than or equal to 1.5. As the water washing step progresses, the atomic concentration ratio of Li/Ni on the particle surface of the Ni-containing lithium transition metal oxide decreases. Therefore, in the present embodiment, for example, the slurry during water washing is periodically collected, the atomic concentration ratio of Li/Ni on the particle surface of the Ni-containing lithium transition metal oxide is measured, and the sulfonic acid compound is added to the slurry when Li/Ni becomes less than or equal to 1.5. Alternatively, a preliminary experiment may be performed in which the elapsed time of the water washing step and the atomic concentration ratio of Li/Ni on the particle surface of the Ni-containing lithium transition metal oxide are measured to previously obtain the time at which the molar ratio of Li/Ni becomes less than or equal to 1.5. The atomic concentration ratio of Li/Ni on the surface of the Ni-containing lithium transition metal oxide can be measured by X-ray photoelectron spectroscopy (XPS).

The amount of the added sulfonic acid compound is preferably adjusted, for example, so that the ratio of the mass of the sulfonic acid compound to the mass of the Ni-containing lithium transition metal oxide is greater than or equal to 0.05 mass %. Too small an amount of the added sulfonic acid compound may result in a low coverage of the sulfonic acid compound on the particle surface of the Ni-containing lithium transition metal oxide, and a small effect of improving battery characteristics.

In the water washing step, for example, the slurry preferably has a slurry concentration of greater than or equal to 500 g/L, and more preferably greater than or equal to 500 g/L and less than or equal to 2000 g/L. The slurry concentration (g/L) means the mass (g) of the Ni-containing lithium transition metal oxide mixed with 1 L of water or an aqueous solution. If the slurry concentration is less than 500 g/L, lithium may be excessively washed away from the Ni-containing lithium transition metal oxide, and the resulting Ni-containing lithium transition metal oxide may affect battery characteristics.

The water washing temperature is, for example, greater than or equal to 10° C. and less than or equal to 40° C. The water washing time is, for example, greater than or equal to 5 minutes and less than or equal to 60 minutes. The water or the aqueous solution to be used is not particularly limited, and from the viewpoint of removing the unreacted lithium compound remaining on the particle surface of the Ni-containing lithium transition metal oxide, for example, water having a measured electrical conductivity of less than 10 S/cm is preferable, and water having a measured electrical conductivity of less than or equal to 1 S/cm is preferable. In a case where an aqueous solution other than water is used for water washing, water may be further used for water washing thereafter to reduce the amount of an impurity contained in the aqueous solution.

### (Solid-Liquid Separation Step)

The solid-liquid separation step is a step of separating the slurry into a solid and a liquid to obtain a cake containing the Ni-containing lithium transition metal oxide. The method of solid-liquid separation is not particularly limited, and the solid-liquid separation is performed with a commonly used apparatus or method. For example, a suction filter, a centrifuge, a filter press, or the like is used. The cake obtained by solid-liquid separation has a water content of, for example, greater than or equal to 2.0 mass % and less than or equal to 10 mass %.

### (Drying Step)

The drying step is a step of drying the cake, obtained in the solid-liquid separation step, containing the Ni-containing lithium transition metal oxide. In the drying step, for example, from the viewpoint of suppressing deterioration of battery characteristics at the time of use as a positive electrode active material for a secondary battery, the cake containing the Ni-containing lithium transition metal oxide is preferably dried until the water content of the cake becomes less than or equal to 1.0 mass %. Drying is preferably performed under the drying condition of, for example, a temperature of greater than or equal to 100° C. and less than or equal to 250° C. in an oxygen atmosphere or a vacuum atmosphere. The drying time is preferably, for example, greater than or equal to 0.5 hours.

The positive electrode active material obtained by such a method for manufacturing is desirably subjected to a sieving treatment in which coarse particles are removed, as necessary. Thus, a positive electrode active material is obtained that is adjusted to a predetermined particle size. Examples of the apparatus used for the sieving treatment include a vibrating sieve and a centrifugal classifier. The positive electrode active material before the sieving treatment may be crushed with a roll mill or the like, as necessary. Crushing refers to dispersing or disentangling aggregated particles.

A secondary battery to which the positive electrode active material produced with the above-described method for manufacturing is applied is obtained, for example, by housing an electrode assembly in which electrodes (positive electrode and negative electrode) and a separator are stacked or wound together with an electrolyte in a housing such as a battery can or a laminate. Hereinafter, the positive electrode, the negative electrode, the separator, and the electrolyte will be described.

The electrolyte has, for example, ion conductivity (for example, lithium ion conductivity). The electrolyte may be a liquid electrolyte (electrolytic solution) or a solid electrolyte.

The liquid electrolyte (electrolytic solution) contains, for example, a non-aqueous solvent and an electrolyte salt dissolved in the non-aqueous solvent. Examples of the non-aqueous solvent to be used include esters, ethers, nitriles, amides, and mixed solvents of greater than or equal to two of them. Examples of the non-aqueous solvent include ethylene carbonate (EC), ethyl methyl carbonate (EMC), dimethyl carbonate (DMC), diethyl carbonate (DEC), and mixed solvents thereof. The non-aqueous solvent may contain a halogen-substituted product in which at least a part of hydrogen in a solvent described above is substituted with a halogen atom such as fluorine (for example, fluoroethylene carbonate or the like). As the electrolyte salt, for example, a lithium salt such as LiPF₆ is used.

As the solid electrolyte, for example, a solid or gel polymer electrolyte, an inorganic solid electrolyte, or the like can be used. The polymer electrolyte contains, for example, a lithium salt and a matrix polymer or contains, for example, a non-aqueous solvent, a lithium salt, and a matrix polymer. As the matrix polymer, for example, a polymer material is used that absorbs a non-aqueous solvent and gelates. Examples of the polymer material include a fluororesin, an acrylic resin, and a polyether resin. Examples of the usable inorganic solid electrolyte include materials known for all-solid-state lithium ion secondary batteries and the like (for example, oxide-based solid electrolytes, sulfide-based solid electrolytes, and halogen-based solid electrolytes). The electrolytes shown as examples above are non-aqueous electrolytes, but the electrolyte is not limited to a non-aqueous electrolyte, and may be an aqueous electrolyte.

The positive electrode includes a positive electrode current collector and a positive electrode mixture layer formed on the positive electrode current collector. The positive electrode mixture layer is preferably formed on both surfaces of the positive electrode current collector. As the positive electrode current collector, a foil of a metal, such as aluminum, being stable in a potential range of the positive electrode, a film having a surface layer on which the metal is disposed, or the like can be used. The positive electrode mixture layer contains the positive electrode active material produced with the above-described method for manufacturing. Furthermore, the positive electrode mixture layer may contain a binding agent, a conductive agent, or the like. The positive electrode can be produced, for example, by applying a positive electrode mixture slurry containing the positive electrode active material, a binding agent, a conductive agent, and the like onto the positive electrode current collector, drying the applied film, and then rolling the applied film to form a positive electrode mixture layer on the positive electrode current collector.

Examples of the conductive agent include carbon materials such as carbon black (CB), acetylene black (AB), Ketjenblack, carbon nanotubes (CNTs), graphene, and graphite. These may be used singly or in combination of greater than or equal to two of them.

Examples of the binding agents that may be used in combination include fluorine-based resins such as polytetrafluoroethylene (PTFE) and polyvinylidene fluoride (PVDF), polyacrylonitrile (PAN), polyimide-based resins, acrylic resins, polyolefin-based resins, carboxymethylcelluloses (CMCs) and salts thereof, and polyethylene oxide (PEO). These may be used singly or in combination of greater than or equal to two of them.

The negative electrode includes a negative electrode current collector and a negative electrode mixture layer formed on the negative electrode current collector. The negative electrode mixture layer is preferably formed on both surfaces of the negative electrode current collector. As the negative electrode current collector, a foil of a metal, such as copper or a copper alloy, being stable in a potential range of the negative electrode, a film having a surface layer on which the metal is disposed, or the like can be used. The negative electrode mixture layer contains, for example, a negative electrode active material, a binding agent, or the like. The negative electrode can be produced, for example, by applying a negative electrode mixture slurry containing a negative electrode active material, a binding agent, and the like onto the negative electrode current collector, drying the applied film, and then rolling the applied film to form a negative electrode mixture layer on the negative electrode current collector.

The negative electrode active material contained in the negative electrode mixture layer is not particularly limited as long as it is capable of reversibly absorbing and releasing lithium ions, and a carbon-based active material such as graphite is generally used. The graphite may be any of natural graphite such as scale-like graphite, massive graphite, or earthy graphite and artificial graphite such as massive artificial graphite or graphitized mesophase carbon microbeads. As the negative electrode active material, a metal to be alloyed with Li, such as Si or Sn, a metal compound containing Si, Sn, or the like, a lithium titanium composite oxide, or the like may be used. As a negative electrode active material other than the carbon-based active material, a silicon-based active material is preferable. Examples of the silicon-based active material include Si-containing compounds represented by SiOₓ (0.5≤x≤1.6) and Si-containing compounds represented by Li_{2y}SiO_{(2+y)} (0<y<2) in which Si fine particles are dispersed in a lithium silicate phase. The amount of the silicon-based active material contained in the negative electrode mixture layer is, for example, preferably greater than or equal to 1 mass % and less than or equal to 15 mass %, and more preferably greater than or equal to 5 mass % and less than or equal to 10 mass % with respect to the total mass of the negative electrode active material.

Examples of the binding agent contained in the negative electrode mixture layer include binding agents similar to those for the positive electrode. Furthermore, the negative electrode mixture layer may contain a conductive agent. Examples of the conductive agent include conductive agents similar to those for the positive electrode.

As the separator, for example, a porous sheet having an ion permeation property and an insulating property is used. Specific examples of the porous sheet include microporous thin films, woven fabrics, and nonwoven fabrics. As the material of the separator, olefin-based resins such as polyethylene and polypropylene, cellulose, and the like are suitable. The separator may be a laminate including a cellulose fiber layer and a thermoplastic resin fiber layer of an olefin-based resin or the like. The separator may be a multilayer separator including a polyethylene layer and a polypropylene layer, and a separator may be used that has a surface to which a material such as an aramid-based resin or a ceramic is applied.

### EXAMPLES

The present disclosure will be further described below with reference to Examples. However, the present disclosure is not limited to these Examples.

### Example 1

An oxide containing Ni as a main component was mixed with lithium hydroxide, then the mixture was fired to obtain a Ni-containing lithium transition metal oxide (LiNi_{0.9}Co_{0.05}Mn_{0.05}O₂), 100 g of the Ni-containing lithium transition metal oxide was mixed with 100 mL of pure water to obtain a slurry (slurry concentration: 1000 g/L), the slurry was stirred, and thus the water washing step was performed for 30 minutes. At the time of elapse of 15 minutes from the start of the water washing step, a solution containing a sulfonic acid compound was added. The solution containing the sulfonic acid compound was produced by adding 100 g of methanesulfonic acid to a LiOH neutralized solution in which 44 g of lithium hydroxide monohydrate was dissolved in 200 g of pure water. At the time of adding the solution containing the sulfonic acid compound, the atomic concentration ratio of Li/Ni on the particle surface of the Ni-containing lithium transition metal oxide was 1.0. The solution containing the sulfonic acid compound was added to the slurry so that the ratio of the mass of the sulfonic acid compound in the solution containing the sulfonic acid compound to the mass of the Ni-containing lithium transition metal oxide was 0.75 mass %.

The slurry after the water washing was separated into a solid and a liquid to obtain a cake containing the Ni-containing lithium transition metal oxide. The obtained cake was heated to 200° C. using a vacuum dryer and dried for 5 hours. The dried cake had a water content of 0.05 mass %.

The dried cake was crushed with a roll mill or the like, and then sieved with a sieve having an opening of 100 m to remove coarse particles. Thus, a positive electrode active material was obtained.

In the positive electrode active material obtained in Example 1, the amount (yield) of the sulfonic acid compound attached to the particle surface of the Ni-containing lithium transition metal oxide was measured and found to be 82%. The amount (yield) of the attached sulfonic acid compound was calculated using the calculation formula “amount of sulfonic acid compound attached to positive electrode active material/amount of added sulfonic acid compound”. The amount of the sulfonic acid compound attached to the positive electrode active material was analyzed by high-frequency induction coupled plasma (ICP).

### [Production of Positive Electrode]

The positive electrode active material, acetylene black as a conductive agent, and polyvinylidene fluoride as a binding agent were mixed at a mass ratio of 98:1:1 to prepare a positive electrode mixture slurry having a solid content of 70%. This slurry was applied to both surfaces of an aluminum foil having a thickness of 15 m, and the applied film was dried and then rolled with a roller to produce a positive electrode in which a positive electrode active material layer was formed on both surfaces of a positive electrode current collector.

### [Production of Negative Electrode]

A graphite powder as a negative electrode active material, carboxymethyl cellulose (CMC) as a binding agent, and styrene butadiene rubber (SBR) were mixed at a mass ratio of 98:1:1, an appropriate amount of water was added to the resulting mixture, and thus a negative electrode mixture slurry was prepared. This slurry was applied to both surfaces of a copper foil having a thickness of 8 m, and the applied film was dried and then rolled with a roller to produce a negative electrode in which a negative electrode active material layer was formed on both surfaces of a negative electrode current collector.

### [Preparation of Non-Aqueous Electrolyte]

To 100 parts by mass of a mixed solvent including ethylene carbonate (EC) and dimethyl carbonate (DMC) (at a volume ratio of EC:DMC=1:3), 5 parts by mass of vinylene carbonate (VC) was added, and LiPF₆ was dissolved in the resulting solvent at a concentration of 1 mol/L to prepare a non-aqueous electrolyte.

### [Production of Non-Aqueous Electrolyte Secondary Battery]

Leads were attached to the positive electrode and the negative electrode, respectively, and then the positive electrode and the negative electrode were wound with a separator interposed therebetween to produce a wound electrode assembly. The electrode assembly was inserted into a case body, and the negative electrode lead was welded to the bottom surface of the case body. Next, the positive electrode lead was welded to a sealing assembly. Thereafter, the non-aqueous electrolyte was injected into the case body, and then the open end of the case body was sealed with the sealing assembly via a gasket to produce a non-aqueous electrolyte secondary battery.

### Example 2

A positive electrode active material was produced in the same manner as in Example 1 except that a slurry obtained by mixing 150 g of the Ni-containing lithium transition metal oxide and 100 mL of pure water (slurry concentration: 1500 g/L) was stirred in the water washing step. At the time of adding the solution containing the sulfonic acid compound, the atomic concentration ratio of Li/Ni on the particle surface of the Ni-containing lithium transition metal oxide was 1.1. In the positive electrode active material obtained in Example 2, the amount (yield) of the sulfonic acid compound attached to the particle surface of the Ni-containing lithium transition metal oxide was 88%. This positive electrode active material was used to produce a non-aqueous electrolyte secondary battery in the same manner as in Example 1.

### Example 3

A positive electrode active material was produced in the same manner as in Example 1 except that LiNi_{0.9}Co_{0.05}Al_{0.05}O₂ was used as the Ni-containing lithium transition metal oxide obtained by mixing an oxide containing Ni as a main component with lithium hydroxide and then firing the mixture. At the time of adding the solution containing the sulfonic acid compound, the atomic concentration ratio of Li/Ni on the particle surface of the Ni-containing lithium transition metal oxide was 1.1. In the positive electrode active material obtained in Example 3, the amount (yield) of the sulfonic acid compound attached to the particle surface of the Ni-containing lithium transition metal oxide was 82%. This positive electrode active material was used to produce a non-aqueous electrolyte secondary battery in the same manner as in Example 1.

### Example 4

A positive electrode active material was produced in the same manner as in Example 1 except that LiNi_{0.9}Co_{0.05}Al_{0.05}O₂ was used as the Ni-containing lithium transition metal oxide obtained by mixing an oxide containing Ni as a main component with lithium hydroxide and then firing the mixture and, in the water washing step, a slurry obtained by mixing 150 g of the Ni-containing lithium transition metal oxide and 100 mL of pure water (slurry concentration: 1500 g/L) was stirred. At the time of adding the solution containing the sulfonic acid compound, the atomic concentration ratio of Li/Ni on the particle surface of the Ni-containing lithium transition metal oxide was 1.2. In the positive electrode active material obtained in Example 4, the amount (yield) of the sulfonic acid compound attached to the particle surface of the Ni-containing lithium transition metal oxide was 86%. This positive electrode active material was used to produce a non-aqueous electrolyte secondary battery in the same manner as in Example 1.

### Example 5

A positive electrode active material was produced in the same manner as in Example 1 except that a slurry obtained by mixing 50 g of the Ni-containing lithium transition metal oxide and 100 mL of pure water (slurry concentration: 500 g/L) was stirred in the water washing step. At the time of adding the solution containing the sulfonic acid compound, the atomic concentration ratio of Li/Ni on the particle surface of the Ni-containing lithium transition metal oxide was 1.2. In the positive electrode active material obtained in Example 5, the amount (yield) of the sulfonic acid compound attached to the particle surface of the Ni-containing lithium transition metal oxide was 59%. This positive electrode active material was used to produce a non-aqueous electrolyte secondary battery in the same manner as in Example 1.

### Example 6

A positive electrode active material was produced in the same manner as in Example 1 except that the solution containing the sulfonic acid compound was added 2 minutes after the start of the water washing step. At the time of adding the solution containing the sulfonic acid compound, the atomic concentration ratio of Li/Ni on the particle surface of the Ni-containing lithium transition metal oxide was 2.0. In the positive electrode active material obtained in Example 6, the amount (yield) of the sulfonic acid compound attached to the particle surface of the Ni-containing lithium transition metal oxide was 25%. This positive electrode active material was used to produce a non-aqueous electrolyte secondary battery in the same manner as in Example 1.

### Example 7

A positive electrode active material was produced in the same manner as in Example 2 except that a powder of the sulfonic acid compound was added in the water washing step. At the time of adding the powder of the sulfonic acid compound, the atomic concentration ratio of Li/Ni on the particle surface of the Ni-containing lithium transition metal oxide was 1.1. In the positive electrode active material obtained in Example 7, the amount (yield) of the sulfonic acid compound attached to the particle surface of the Ni-containing lithium transition metal oxide was 85%. This positive electrode active material was used to produce a non-aqueous electrolyte secondary battery in the same manner as in Example 1.

### Comparative Example 1

An oxide containing Ni as a main component was mixed with lithium hydroxide, then the mixture was fired to obtain a Ni-containing lithium transition metal oxide (LiNi_{0.9}Co_{0.05}Mn_{0.05}O₂), and a solution containing a sulfonic acid compound was added. That is, the solution containing the sulfonic acid compound was added without performing the water washing step. Then, the resulting mixture was sieved with a sieve having an opening of 100 m to remove coarse particles, and thus a positive electrode active material was obtained. In the positive electrode active material obtained in Comparative Example 1, the amount (yield) of the sulfonic acid compound attached to the particle surface of the Ni-containing lithium transition metal oxide was 11%. This positive electrode active material was used to produce a non-aqueous electrolyte secondary battery in the same manner as in Example 1.

### Comparative Example 2

An oxide containing Ni as a main component was mixed with lithium hydroxide, then the mixture was fired to obtain a Ni-containing lithium transition metal oxide (LiNi_{0.9}Co_{0.05}Mn_{0.05}O₂), and the Ni-containing lithium transition metal oxide was used as a positive electrode active material in Comparative Example 2. That is, in Comparative Example 2, no sulfonic acid compound was added. This positive electrode active material was used to produce a non-aqueous electrolyte secondary battery in the same manner as in Example 1.

### [Charge-Discharge Test]

The non-aqueous electrolyte secondary battery in each of Examples and Comparative Examples was charged at a constant current of 0.5 C under a temperature environment of 25° C. until the battery voltage reached 4.2 V, and then discharged at a constant current of 0.5 C until the battery voltage reached 2.5 V The charge capacity and the discharge capacity at this time were measured, and the charge-discharge efficiency was determined with the following formula.

$$Charge - discharge efficiency = ( discharge capacity / charge capacity ) \times 100$$

Table 1 summarizes the manufacturing conditions of the positive electrode active material in each of Examples and Comparative Examples. Table 2 summarizes the result of the amount (yield) of the sulfonic acid compound attached to the particle surface of the Ni-containing lithium transition metal oxide and the result of the charge-discharge efficiency in each of Examples and Comparative Examples. The charge-discharge efficiency is described using the value of Comparative Example 1 as a reference (1.00), and thus the values of other Examples and Comparative Example are described as a relative value.

TABLE 1

| | Ni-containing lithium | | | | | | Sulfonic acid compound | | | |
|---|---|---|---|---|---|---|---|---|---|---|
| | transition metal oxide | | | | Water washing step | | Amount of | | | |
| | Transition metal ratio | | | | | Water | added | | | Li/Ni |
| | (mol %) | | | | Slurry | washing | compound | Timing of | Form of | molar |
| | Ni | Co | Al | Mn | concentration | time | (wt %) | addition | addition | ratio * |
| Example 1 | 90 | 5 | 0 | 5 | 1000 g/L | 30 Min | 0.75 | 15 Minutes after | Solution | 1.0 |
| | | | | | | | | start of water | | |
| | | | | | | | | washing step | | |
| Example 2 | 90 | 5 | 0 | 5 | 1500 g/L | 30 Min | 0.75 | 15 Minutes after | Solution | 1.1 |
| | | | | | | | | start of water | | |
| | | | | | | | | washing step | | |
| Example 3 | 90 | 5 | 5 | 0 | 1000 g/L | 30 Min | 0.75 | 15 Minutes after | Solution | 1.1 |
| | | | | | | | | start of water | | |
| | | | | | | | | washing step | | |
| Example 4 | 90 | 5 | 5 | 0 | 1500 g/L | 30 Min | 0.75 | 15 Minutes after | Solution | 1.2 |
| | | | | | | | | start of water | | |
| | | | | | | | | washing step | | |
| Example 5 | 90 | 5 | 0 | 5 | 500 g/L | 30 Min | 0.75 | 15 Minutes after | Solution | 1.2 |
| | | | | | | | | start of water | | |
| | | | | | | | | washing step | | |
| Example 6 | 90 | 5 | 0 | 5 | 1000 g/L | 30 Min | 0.75 | 2 Minutes after | Solution | 2.0 |
| | | | | | | | | start of water | | |
| | | | | | | | | washing step | | |
| Example 7 | 90 | 5 | 0 | 5 | 1500 g/L | 30 Min | 0.75 | 15 Minutes after | Powder | 1.1 |
| | | | | | | | | start of water | | |
| | | | | | | | | washing step | | |
| Comparative | 90 | 5 | 0 | 5 | — | — | 0.75 | — | Solution | — |
| Example 1 | | | | | | | | | | |
| Comparative | 90 | 5 | 0 | 5 | 1000 g/L | 30 Min | 0 | — | | — |
| Example 2 | | | | | | | | | | |

* Li/Ni atomic concentration ratio: the Li/Ni atomic concentration ratio on the particle surface of the Ni-containing lithium transition metal oxide at the time of adding the solution containing the sulfonic acid compound

TABLE 2

| | Amount (yield) | |
|---|---|---|
| | of attached | Charge- |
| | sulfonic acid | discharge |
| | compound | efficiency |
| Example 1 | 82% | 1.015 |
| Example 2 | 88% | 1.018 |
| Example 3 | 82% | 1.020 |
| Example 4 | 86% | 1.018 |
| Example 5 | 59% | 1.007 |
| Example 6 | 25% | 1.004 |
| Example 7 | 85% | 1.016 |
| Comparative Example 1 | 11% | 1.000 |
| Comparative Example 2 | — | 0.993 |

The amount (yield) of the sulfonic acid compound attached to the particle surface of the Ni-containing lithium transition metal oxide was higher in Examples 1 to 7 than in Comparative Example 1. From this fact, it can be said that the addition of the sulfonic acid compound in the water washing step of the Ni-containing lithium transition metal oxide can improve the amount of the sulfonic acid compound attached to the particle surface of the Ni-containing lithium transition metal oxide. In comparison among Examples 1 to 7, the amount of the sulfonic acid compound attached to the particle surface of the Ni-containing lithium transition metal oxide was more improved in Examples 1 to 5 in which the sulfonic acid compound was added when the atomic concentration ratio of Li/Ni on the surface of the Ni-containing lithium transition metal oxide became less than or equal to 1.5 than in Example 6 in which the sulfonic acid compound was added before the above atomic concentration ratio of Li/Ni became less than or equal to 1.5.

The result from the viewpoint of battery characteristics was that the charge-discharge efficiency was higher in Examples 1 to 6 showing a large amount of the sulfonic acid compound attached to the particle surface of the Ni-containing lithium transition metal oxide than in Comparative Examples 1 to 2.

### [Supplementary Notes]

(1)

A method for manufacturing a positive electrode active material for a secondary battery, the method including:
a water washing step of mixing a Ni-containing lithium transition metal oxide and water or an aqueous solution to obtain a slurry and stirring the slurry to water-wash the Ni-containing lithium transition metal oxide;
a solid-liquid separation step of separating the slurry into a solid and a liquid to obtain a cake containing the Ni-containing lithium transition metal oxide; and
a drying step of drying the cake,
the water washing step including adding a sulfonic acid compound to the slurry, the sulfonic acid compound represented by General Formula (I) described below:

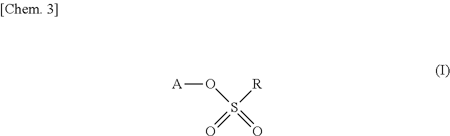

wherein A represents H, Li, or Na, and R represents H or a hydrocarbon group.
(2)

The method for manufacturing a positive electrode active material for a secondary battery according to (1) above, wherein in the water washing step, the sulfonic acid compound is added to the slurry after an atomic concentration ratio of Li/Ni on a surface of the Ni-containing lithium transition metal oxide becomes less than or equal to 1.5.
(3)

The method for manufacturing a positive electrode active material for a secondary battery according to (1) or (2) above, wherein the slurry has a slurry concentration of greater than or equal to 500 g/L.
(4)

The method for manufacturing a positive electrode active material for a secondary battery according to any one of (1) to (3) above, wherein in the drying step, the cake is dried until a water content of the cake becomes less than or equal to 0.05 mass %.
(5)

The method for manufacturing a positive electrode active material for a secondary battery according to any one of (1) to (4) above, wherein the sulfonic acid compound is attached, in an amount of greater than or equal to 80 mass % of a total amount of the sulfonic acid compound added to the slurry, to the surface of the Ni-containing lithium transition metal oxide.

1. A method for manufacturing a positive electrode active material for a secondary battery, the method comprising:
a water washing step of mixing a Ni-containing lithium transition metal oxide and water or an aqueous solution to obtain a slurry and stirring the slurry to water-wash the Ni-containing lithium transition metal oxide;
a solid-liquid separation step of separating the slurry into a solid and a liquid to obtain a cake containing the Ni-containing lithium transition metal oxide; and
a drying step of drying the cake,
the water washing step including adding a sulfonic acid compound to the slurry, the sulfonic acid compound represented by General Formula (I) described below: 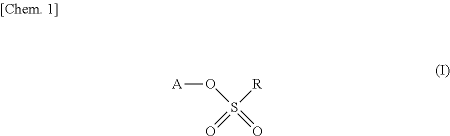
wherein A represents H, Li, or Na, and R represents H or a hydrocarbon group.

2. The method for manufacturing a positive electrode active material for a secondary battery according to claim 1, wherein in the water washing step, the sulfonic acid compound is added to the slurry after an atomic concentration ratio of Li/Ni on a particle surface of the Ni-containing lithium transition metal oxide becomes less than or equal to 2.0.

3. The method for manufacturing a positive electrode active material for a secondary battery according to claim 1, wherein the slurry has a slurry concentration of greater than or equal to 500 g/L.

4. The method for manufacturing a positive electrode active material for a secondary battery according to claim 1, wherein in the drying step, the cake is dried until a water content of the cake becomes less than or equal to 0.05 mass %.

5. The method for manufacturing a positive electrode active material for a secondary battery according to claim 1, wherein the sulfonic acid compound is attached, in an amount of greater than or equal to 80 mass % of a total amount of the sulfonic acid compound added to the slurry, to the particle surface of the Ni-containing lithium transition metal oxide.
